(19) United States
(12) Patent Application Publication
(10) Pub. No.: US 2010/0124319 A1
(43) Pub. Date: May 20, 2010

(54) CALL DISPLAYING SYSTEM AND METHOD OF USING THE SAME

(75) Inventor: YIN-FANG CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/504,777

(22) Filed: Jul. 17, 2009

(30) Foreign Application Priority Data
Nov. 17, 2008 (CN) 200810305590.3

(51) Int. Cl. H04M 1/56

(52) U.S. Cl. 379/142.17

(57) ABSTRACT

A call displaying system includes a base station, a calling terminal and at least one called terminal, the calling terminal and the receiving terminals are wireless communicated with the base station. The base station includes a signal controlling unit, a signal communicating unit and a signal storage unit. The signal controlling unit is electronically connected to the signal communicating unit and the signal storage unit. The calling terminal sets call displaying images, and the call displaying images are sent to the signal communicating unit under the control of the signal controlling unit. The call displaying images are stored in the signal storage unit and sent to the receiving terminals under the control of the signal controlling unit. The called terminal rejects the call displaying images or uses the call displaying images.

### BACKGROUND

### Technical Field

The disclosure relates to call displaying systems and call displaying methods, particularly, to a call displaying system and a call displaying method for selectively displaying call displaying images.

Many mobile terminals for wireless communication, such as mobile phones, have the function of displaying call numbers. However, it is difficult for users to identify the callers based solely on the telephone numbers. Therefore, other information of callers, such as images/photos, can be displayed along with the telephone numbers allowing easier recognition to the users.

The images of contacts are generally stored in the mobile terminals. However, the memory capacities of most mobile terminals are generally small, thus may not be able to occupy a large amount of data e.g. numbers, images, and may also slow down the processing speed of the mobile terminal.

Therefore, there is a room for improvement within the art.

### BRIEF DESCRIPTION OF THE DRAWINGS

Many aspects of a call displaying system and method of using the same can be better understood with reference to the following drawings. The components in the drawings are not necessarily to scale, the emphasis instead being placed upon clearly illustrating the principles of the present call displaying system and method using the same. Moreover, in the drawings, like reference numerals designate corresponding parts throughout the several views.

FIG. 1 is a block diagram of a call displaying system, according to an exemplary embodiment.

FIG. 2 is a flow chart illustrating a method of displaying telephone numbers and call displaying images, according to an exemplary embodiment.

### DETAILED DESCRIPTION OF THE EMBODIMENTS

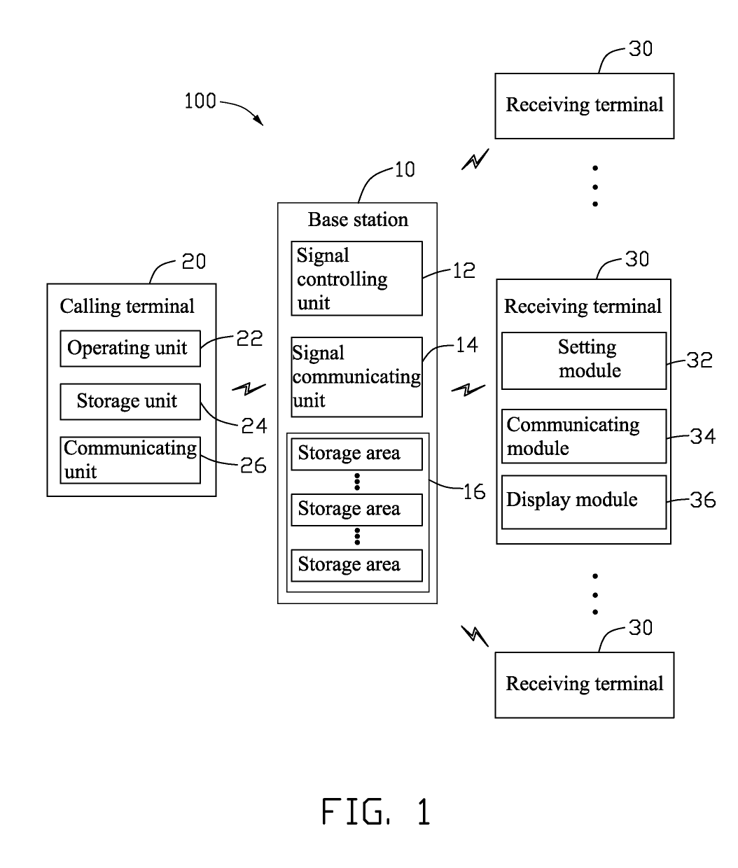

Referring to FIG. 1, a call displaying system 100 includes a base station 10, a calling terminal 20 and a plurality of receiving terminals 30 The calling terminal 20 and each receiving terminals 30 are wireless communication devices, such as mobile phones or personal digital assistants (PDAs), etc. When the calling terminal 20 communicates with the receiving terminals 30 via the base station 10, photos of the user of the calling terminal 20 previously stored in the base station 10, can be set as call displaying images, and the call displaying images are sent to the receiving terminals 30 via the base station 10.

The base station 10 can be a conventional base station of cell phones and includes a signal controlling unit 12, a signal communicating unit 14 and a signal storage unit 16. The signal controlling unit 12 is a processor electronically connected to the signal communicating unit 14 and the signal storage unit 16.

The signal controlling unit 12 controls the signal communicating unit 14 to receive the call displaying images and telephone numbers from the calling terminal 20 and send the call displaying images and telephone numbers to the receiving terminals 30. The signal communicating unit 14 can be a conventional antenna device. The signal storage unit 16 is a memory for storing the call displaying images and telephone numbers set by the user of the calling terminal 20 under the control of the signal controlling unit 12.

The calling terminal 20 includes an operating unit 22, a storage unit 24 and a communicating unit 26. The operating unit 22 is electronically connected to the storage unit 24 and the communicating unit 26.

The operating unit 22 is configured for setting the call displaying images to be transferred by the calling terminal 20 to the base station 10. The operating unit 22 can be a typical signal input device of the calling terminal 20, such as a keypad. The storage unit 24 is a memory for temporary storing the call displaying images set by the operating unit 22 and the storage unit 24 can be a conventional storage device of the calling terminal 20, such as a subscriber identify model (SIM) card. The calling terminal 20 sends a requesting signal to the signal controlling unit 12 through the communicating unit 26. Then, the signal controlling unit 12 establishes a plurality of storage areas in the signal storage unit 16 in response to the requesting signal. Then, the call displaying images are sent to the storage areas and are stored in the storage areas of the signal storage unit 16. The communicating unit 26 can be integrated with an existing transmission device, such as an antenna.

Each called terminal 30 includes a setting module 32, a communicating module 34 and a display module 36. The setting module 32 is electronically connected to the communicating module 34 and the displaying module 36. The setting module 32 is used to select whether or not to use the call displaying images sent by the calling terminal 20. If the setting module 32 selects to use the call displaying images, then the communicating module 34 receives the images and telephone numbers from the signal communicating unit 14, and then both the images and the telephone numbers are displayed on the displaying module 36. If the setting module 32 selects not to use the call displaying images, then the communicating module 34 only receives the telephone numbers sent from the signal communicating unit 14, and the telephone numbers are displayed on the displaying module 36. The setting module 32 can be a conventional signal input device of the called terminal 30, such as a keypad. The communicating module 34 can be integrated with an existing transceiving device, such as an antenna. The displaying module 36 can a typical liquid crystal display module (LCM).

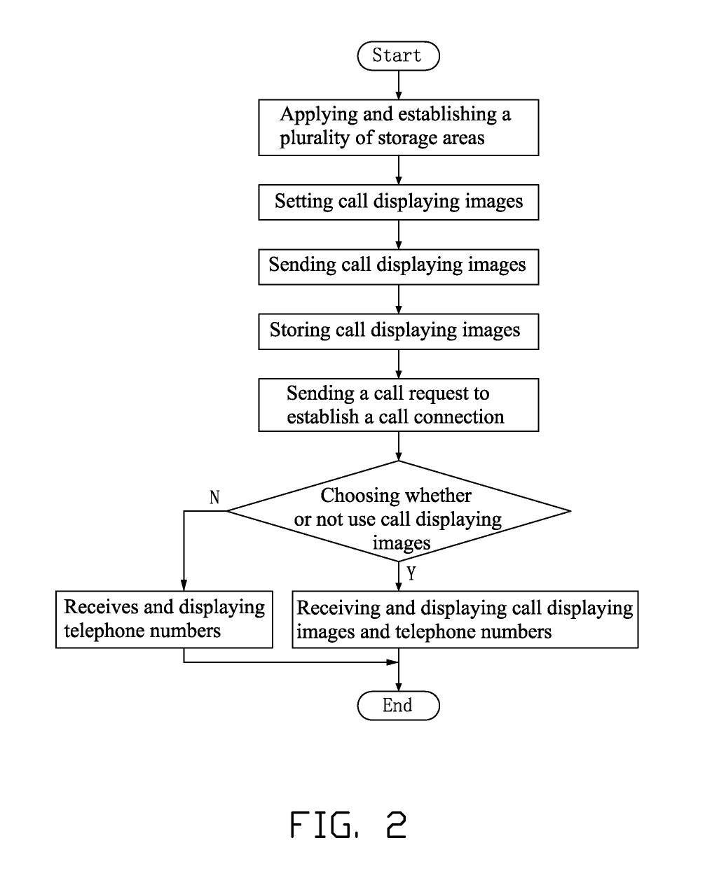

Also referring to FIG. 2, a call displaying method in accordance with an exemplary embodiment is depicted. The call displaying method can use the aforementioned call displaying system 100 to transmit the call displaying images and telephone numbers. The call displaying method may at least include the following steps.

A call displaying system 100 is provided.

The calling terminal 20 sends a requesting signal to the signal controlling unit 12 through the communicating unit 26. Then, the signal controlling unit 12 establishes a plurality of storage areas in the signal storage unit 16 in response to the requesting signal.

The call displaying images for each called terminal 30 are set in the calling terminal 20 via the operating unit 22.

The call displaying images set by the operating unit 22 are sent to the signal communicating unit 14 via the communicating unit 26 of the calling terminal 20. Understandably, the telephone numbers of the calling terminal 20 can be sent to the base station 10 via the communicating unit 26.

The call displaying images set by the operating unit 22 and the telephone numbers of the calling terminal 20 are stored in the corresponding storage area of the signal storage unit 14 controlled by the controlling device 12.

The calling terminal 20 sends a call request to the base station 10 and establishes a call connection with one called terminal 30 via the base station 10.

The setting module 32 of one called terminal 30 chooses whether or not to use the call displaying images sent by the calling terminal 20. If the setting module 32 chooses to use the call displaying images, then the calling terminal 20 establishes the call connection with the called terminal 30, and the communicating module 34 receives the images and telephone numbers sent by the signal communicating unit 14 of the base station 10, and the images and telephone numbers are displayed on the displaying module 36. If the setting module 32 chooses not to use the call displaying images, then the calling terminal 20 still establishes the call connection with the called terminal 30 via the communicating module 34. The communicating module 34 only receives the telephone numbers of the calling terminal 20, and the telephone numbers and/or existing images stored in the called terminal 30 are displayed on the displaying module 36.

Understandably, the images stored in the storage areas of signal storage unit 16 can be modified at anytime through the calling terminal 20.

Understandably, in the call displaying system 100 of the exemplary embodiment, the call displaying images are not stored in the called terminal 30 and the storage unit 24 of the calling terminal 20 but in the signal storage unit 16 of the base station 10, thus the calling terminal 20 and the called terminal 30 have more free memories. In this way, the processing speed of the calling terminal 20 and receiving terminals 30 are greatly increased.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A call displaying system, comprising:
a base station including a signal controlling unit, a signal communicating unit and a signal storage unit, the controlling device being electronically connected to the signal communicating unit and the signal storage unit;
a calling terminal communicating with the base station, setting call displaying images and sending the call displaying image to the base station via the signal communicating unit under the control of the signal controlling unit; and
a called terminal communicating with the calling terminal via the base station, the call displaying images being stored in the signal storage unit controlled by the signal controlling unit; when the calling terminal establishing a call connection with the called terminal via the base station, the call displaying images being selectively sent to the called terminal via the signal communication device.

2. The call displaying system as claimed in the claim 1, wherein the calling terminal includes an operating unit configured for setting call displaying images.

3. The call displaying system as claimed in the claim 1, wherein the calling terminal includes a storage unit configured for temporarily storing the call displaying images set by the calling terminal.

4. The call displaying system as claimed in the claim 1, wherein the calling terminal includes a communicating unit configured for sending the call displaying images set by the calling terminal to the signal communicating unit of the base station.

5. The call displaying system as claimed in the claim 1, wherein the called terminal includes a setting module configured for selecting whether or not to use the call displaying images sent by the calling terminal.

6. The call displaying system as claimed in the claim 5, wherein the called terminal includes a communicating module configured for receiving the call displaying images and telephone numbers of the calling terminal; when the setting module select to use the call displaying images sent by the calling terminal, then the communicating module receives the images and the telephone numbers; when the setting module select not to use the displaying images, then the communicating module only receives the telephone numbers.

7. The call displaying system as claimed in the claim 5, wherein the called terminal includes a displaying module configured for displaying the images and telephone numbers of the calling terminal.

8. The call displaying system as claimed in the claim 1, further comprising a plurality of receiving terminals, the call terminals communicate with the calling terminal via the base station and selectively receive the call displaying images of the calling terminal.

9. A call displaying method, comprising steps of:
providing a call displaying system, the call displaying system including a base station, a calling terminal and a called terminal, the calling terminal communicating information with the called terminal via the base station, the base station including a signal controlling unit, a signal communicating unit and a signal storage unit;
setting call displaying images via the calling terminal;
sending the call displaying images to the signal communicating unit of the base station;
storing the call displaying images in the signal storage unit of the base station;
sending a calling to the called terminal via the base station; and
receiving the calling sent by the calling terminal.

10. The call displaying method as claimed in claim 9, wherein the call displaying system includes a plurality of receiving terminals, the call terminals communicate with the calling terminal via the base station and selectively receive the call displaying images of the calling terminal.

11. The call displaying method as claimed in claim 9, further comprising a step of sending an application to the signal storage unit to establish a plurality of storage areas in the signal storage unit.

12. The call displaying method as claimed in claim 11, further comprising a step of setting a plurality of storage areas in the signal storage unit of the base station, and storing the call displaying images sent by the calling terminal in the storage areas.

13. The call displaying method as claimed in claim 9, further comprising a step of sending a call request to base station to establish a call connection with called terminal via the base station.

14. The call displaying method as claimed in claim 13, further comprising a step of choosing whether or not use the call displaying images sent by the calling terminal in the called terminal.

15. The call displaying method as claimed in claim 14, further comprising a step of establishing the call connection with the calling terminal and receiving the call displaying images and telephone numbers of the calling terminal when choosing to use the call displaying images sent by the calling terminal.

16. The call displaying method as claimed in claim 14, further comprising a step of establishing the call connection with the calling terminal and receiving the telephone numbers of the calling terminal when choosing not to use the call displaying images sent by the calling terminal.
